(19) United States
(12) Patent Application Publication
(10) Pub. No.: US 2005/0080646 A1
(43) Pub. Date: Apr. 14, 2005

(54) Electronic management of change

(75) Inventor: Wayne Garland, Kingsport, TN (US)

Correspondence Address: Charles W. Calkins, Esq.;Kilpatrick Stockton LLP, 1001 West Fourth Street, Winston-Salem, NC, 27101, US

(73) Assignee: Eastman Chemical Company, a Delaware corporation, Kingsport, TN (US)

(21) Appl. No.: 10/897,828

(22) Filed: Jul. 23, 2004

Related U.S. Application Data
(60) Provisional application No. 60/490,185, filed on Jul. 25, 2003.

(51) Int. Cl. G06F 17/60

(52) U.S. Cl. 705/1

(57) ABSTRACT

Systems and methods that electronically manage and administer Management of Change within an organization are described. One described method comprises receiving a change request comprising a plurality of tasks, initiating the change request, validating the change request, and approving the change request. The change request may be, for example, associated with one of a facility change, a bill of materials change, an operations procedure change.

### CROSS-REFERENCE TO RELATED APPLICATIONS

This application claims the benefit of U.S. Provisional Application No. 60/490,185, filed Jul. 25, 2003, the entirety of which is hereby incorporated by reference.

### FIELD OF INVENTION

The present invention provides systems and methods that electronically manage, administer and facilitate change processes within an organization. Systems and methods of the present invention are advantageous for “Management of Change” which under OSHA Process Safety Management regulations, involves a procedure for approving and documenting plant procedural or physical changes.

### BACKGROUND

Most organizations undergo change in personnel, processes, procedures and the like. In the chemical industry, Management of Change policies and procedures are designed to insure that changes within chemical process plants do not result in operations being conducted outside of established safety parameters.

Although use of computers and computer networks have become common within organizations, Management of Change has remained a process based on printed documents, telephone calls, forms with many resulting inefficiencies that result in costs to an organization. Accordingly, there is a need for an electronic system for administering Management of Change.

### SUMMARY OF THE INVENTION

The present invention provides systems and methods that electronically manage and administer Management of Change within an organization.

In one embodiment of the present invention, a method comprises receiving a change request comprising a plurality of tasks, initiating the change request, validating the change request, and approving the change request. In embodiments of the present invention, the change request may be associated with one of a facility change, a bill of materials change, an operations procedure change.

The method may further comprise executing the change request. In one embodiment, executing the change request comprises: designing a process corresponding to the change request, constructing the process corresponding to the change request, and implementing the process corresponding to the change request. In another embodiment, executing the change request comprises generating an audit trail.

Validating the change request may comprise performing a safety validation. In one embodiment, the method further comprises receiving at least one approval type prior to approving the change. The approval type may comprise at least one of an operations concept approval, a safety coordinator approval, an environmental coordinator approval, a quality coordinator approval, a training coordinator approval, a maintenance coordinator approval, and a concept approval. The concept approval of such an embodiment may comprise at least one of a HAZCOMM (OSHA's Hazard Communication Standard) review, a TSCA (Toxic Substances Control Act) review, a formal safety review, a formal environmental review, and a formal quality review.

One method according to an embodiment of the present invention comprises automatically routing the change request to a user responsible for completion of a task associated with the change request.

In another embodiment, a computer-readable medium (such as, for example random access memory or a computer disk) comprises code for carrying out such a method.

Management of Change or “MOC” is tool to assure that projects meet regulatory and company requirements and to help originators get their projects done safely and efficiently.

Management of Change may be very complex and involve many different groups and individuals. A Management of Change process will generally include a number of tasks with each task being performed by one or more individuals. Tasks, and/or their completion, may be reviewed or approved by other individuals.

By way of example, in an embodiment of the present invention utilized in a management of change for chemical processes, the tasks may include the tasks set forth in the appended figures.

Embodiments of a system of the present invention may be advantageously designed to meet regulatory and business requirements such as those established by the US Government's Occupational Safety and Health Administration (OSHA), Environmental Protection Agency (EPA), Food and Drug Administration (FDA); and business practices such as ISO requirements, cGMP requirements, GLP requirements, TSCA, NFPA, National Electric Code, Life Safety Code, Fire Prevention Code.

ASME Boiler & Pressure Vessel Code, and the like. As described above, embodiments of the present invention may provide an audit trail that allows compliance with these types of regulations.

For example, in the United States, 29 Code of Federal Regulations (OSHA) Section 1910 requires that an employer shall establish and implement written procedures to manage changes (except for “replacements in kind”) to process chemicals, technology, equipment, and procedures; and, changes to facilities that affect a covered process. The adopted procedures are required to address at least the following considerations prior to any proposed change: the technical basis for the proposed change; the impact of change on safety and health; modifications to operating procedures; necessary time period for the change; and, authorization requirements for the proposed change. The regulations further require that employees involved in operating a process and maintenance, and contract employees whose job tasks will be affected by a change in the process, shall be informed of, and trained in, the change prior to of the process or the affected part of the process. In addition, an employer (plant operator) must perform a pre-startup safety review for new facilities and for modified facilities when the modification is significant enough to require a change in the process safety information. The pre-startup safety review must confirm that prior to the introduction of highly hazardous chemicals to a process: construction and equipment is in accordance with design specifications; safety, operating, maintenance, and emergency procedures are in place and are adequate; training of each employee involved in operating a process has been completed; for new facilities, a process hazard analysis has been performed and recommendations have been resolved or implemented before startup; and modified facilities meet the requirements set forth above.

The systems and methods of the present invention meet or exceed each of these regulatory requirements.

In addition, from a regulatory perspective, documentation is critical. If it isn't documented, there is no proof that it was done. Documentation includes not only what was done but also when it was done. A feature of the systems and methods of the present invention is the documentation of all tasks.

In an aspect the present invention provides an electronic system for management of change among a plurality of individuals on a computer network the system comprising: a task creation template; an electronic mail router; a database including a routing and approval table wherein tasks created in the task creation template are routed by electronic mail to individuals on the computer network according to information in the database.

In another aspect, the present invention provides a standardized electronic management of change system. The system provides an electronic format for handling forms, drawings, standard operating procedures, documents and other items utilized in management of change processes, collectively referred to herein as “management of change documentation”, that heretofore, at least in part, were paper based. The system maintains management of change documentation associated with a particular project together through the use of an assigned unique identification number. Another feature of an embodiment of a system of the present invention is the automation of functions including routing of: documents, drawings, approvals and the like; tracking; notification; reporting; printing; searching; and the creation of audit trails. Routing and other functions in embodiments of the present invention may be performed utilizing electronic mail. The system may further include one or more of the following controls: Additional training; Improved checklists; Automatic routing; Automatic reminders for each task; Detailed instructions for each task; Automatic tracking; Automatic flagging; Automatic reports; and/or Electronic files with automatic backup to reduce the risk of losing information.

Embodiments of systems and methods of the present invention may be designed to work or without electronic drawings. Further, electronic red-lining may be made available and electronic drawings can be attached if desired (generally for designers to issue for approval and construction).

Embodiments of a system of the present invention may be utilized by users that do not have an understanding of management of change processes or knowledge of the steps in the process. The system will prompt users to complete a task, or tasks, and then automatically route information relating to the completed task to other users. Thus an individual assigned a task need not know the individual assigning the task, the individual who will approve the task, or other individuals involved in the process, including individuals responsible for auditing the completion of the task. Further, embodiments of the present invention allow routing of tasks to alternative individuals if a primary individual is absent or on vacation. In addition to the individuals established by the system for completion of tasks, embodiments of the present invention allow specified individuals, for example supervisors, to add individuals to a project workflow to accommodate specialists and other individuals.

In an embodiment, the process performed by a system of the present invention is originator driven. The originator is responsible for keeping the project moving.

The workflow may comprise a few required steps plus a large number of optional steps which can be utilized as needed. Site specific requirements (incl. site size) may be handled through: Optional attachments; Roles databases; Site procedures; and Provisions for emergency Management of Change processes (verbal approval).

In an embodiment, a system of the present invention may be form driven wherein the how the form is filled out largely determines the routing. Examples of forms and templates are shown in the appended Figures and discussed more fully below. The mandatory steps which are triggered are primarily dependent upon which MOC type is selected.

Embodiments of systems and methods of the present invention may be produced utilizing document management software. Embodiments may run on standard computer hardware and software, including PC's, web servers and the like running various operating systems including Microsoft, Unix, Linux, Sun or Apple operating systems.

An advantage of the systems and methods of the present invention is their ease of use.

A further advantage of the systems and methods of the present invention is their flexibility.

A further advantage of the systems and methods of the present invention is that their ease of use reduces training costs.

A further advantage of the systems and methods of the present invention is embodiments utilize the types of software and hardware generally found on enterprise networks.

A further advantage of the systems and methods of the present invention is that records are maintained and easily retrieved, thereby minimizing or elimination lost records.

A further advantage of the systems and methods of the present invention is that the systems and methods facilitate tracking of projects.

A further advantage of the systems and methods of the present invention is that many tasks, not requiring human input, are completely automated, thereby reducing labor and increasing compliance assurance.

A further advantage of the systems and methods of the present invention is that they allow for improved sharing of best practices.

These embodiments are mentioned not to limit or define the invention, but to provide examples of embodiments of the invention to aid understanding thereof. Embodiments are discussed in the Detailed Description, and further description of the invention is provided there. Advantages offered by the various embodiments of the present invention may be further understood by examining this specification. Further details and advantages of the present invention are set forth below with reference to a particular embodiment of the present invention.

### BRIEF DESCRIPTION OF THE DRAWINGS

FIGS. 1-13 depict provide a schematic overview of an embodiment of the present invention and screenshots of a possible embodiment of the present invention. The Figures are discussed in more detail below.

### DETAILED DESCRIPTION OF AN EMBODIMENT

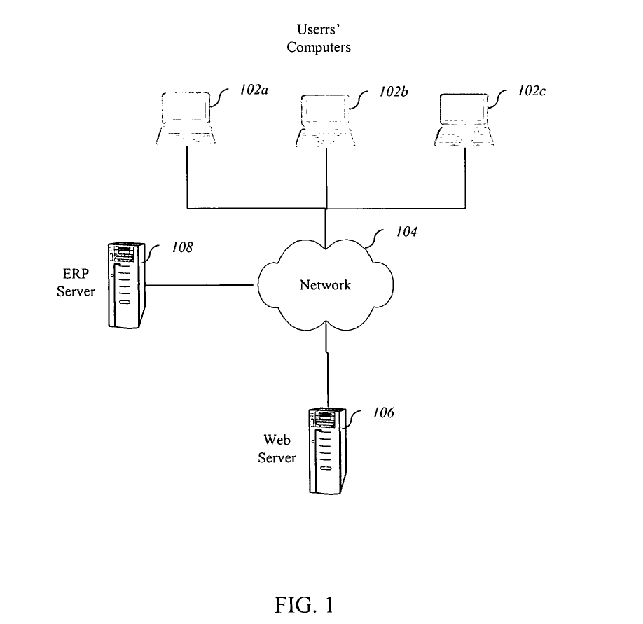

An embodiment of this invention provides systems and methods for the management of change (“MOC”). Referring now to the drawings in which like numerals indicate like elements among the several figures, FIG. 1 is an exemplary environment for implementing one embodiment of this invention. The environment shown in FIG. 1 is referred to herein as the management of change (“MOC”) system. The MOC system includes program code to implement a process, which is referred to herein as the MOC process.

The embodiment shown in FIG. 1 includes a plurality of users' computers 102a-c. The computers 102a-c are in communication with a network 104. The network 104 may be any public, private, or governmental network, such as the Internet or an intranet. The users' computers 102a-c use the network 104 to access a web server 106. In the embodiment shown, the web server 106 includes a computer-readable medium and a processor for storing and executing program code for implementing the MOC process. The embodiment shown also includes an ERP server 108 in communication with the network 104. In the embodiment shown, the users' computers 102a-c, the network 104, the web server 106, and the ERP system 108 are all elements of the MOC system.

In the embodiment shown, the MOC system program code executes on the processors on the users' computers 102a-c, web server 106, and ERP server 108. In various embodiments, the processor may include, for example, digital logic processors capable of processing input, executing algorithms, and generating output as necessary in response to the inputs received from the user interface or other elements of the MOC system. Such processors may include a microprocessor, an application-specific integrated circuit (ASIC), and state machines. Such processors include, or may be in communication with, media. This media may be computer-readable media, which stores instructions that cause the processor to perform the steps described herein, when the processor executes these instructions.

Embodiments of computer-readable media include, but are not limited to, an electronic, optical, magnetic, or other storage or transmission device capable of providing a processor, such as the processor of the web server 104, with computer-readable instructions. Other examples of suitable media include, but are not limited to, a floppy disk, CD-ROM, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel both wired and wireless. The instructions may comprise code from any computer-programming language, including, for example, C, C#, Visual Basic, Java, and JavaScript.

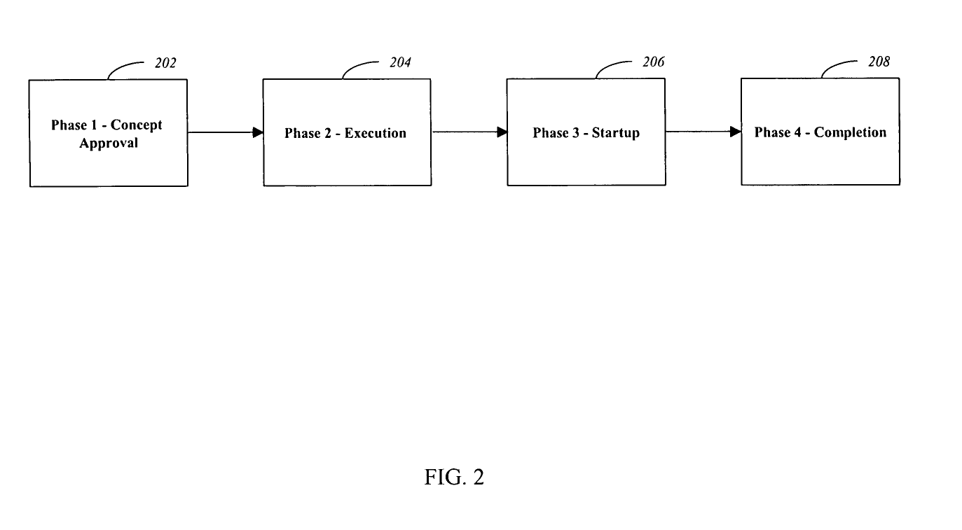

FIG. 2 is a flowchart illustrating the high-level process steps or phases of the MOC process in one embodiment of this invention. The embodiment shown provides a multi-step workflow process. The MOC process may vary depending on the type of change being managed. For example, the process for a change to a physical facility may involve different steps than the process for a change to a computer program. In the embodiment shown, an individual process step may or may not be relevant to a particular requested change. The originator of a request determines which process steps are relevant for a particular change and provides this information to the MOC System. A particular workflow step may be relevant to the workflow of every change. Other workflow steps are selectively executed by the system.

In an embodiment of this invention, the originator of a change may be a person or an automated process. For example, a change in a bill or materials for a product may trigger a corresponding change in a product label that requires regulatory review and approval. In such a case, the enterprise resource planning (ERP) system managing the bill or materials for the product generates a change in the MOC System, specifying the relevant steps in the MOC process. In one embodiment, a person uses a computer 102a to selectively enter specific information about a change in a computer-readable form and submits the form for processing by the MOC system.

Referring again to FIG. 2, the MOC process includes four phases: concept approval 202; execution 204; startup 206; and completion 208. In one embodiment described herein, the concept approval phase 202 includes the steps necessary to initiate a change. These steps include change proposal, initiation, and approval. The execution phase 204 includes the steps of change review, design, and construction 204. The startup phase 206 includes the steps of change training, safety validation, and implementation. The completion phase 208 includes the steps of updates and archival of change documentation. Each of the steps within the high-level phases may include additional steps.

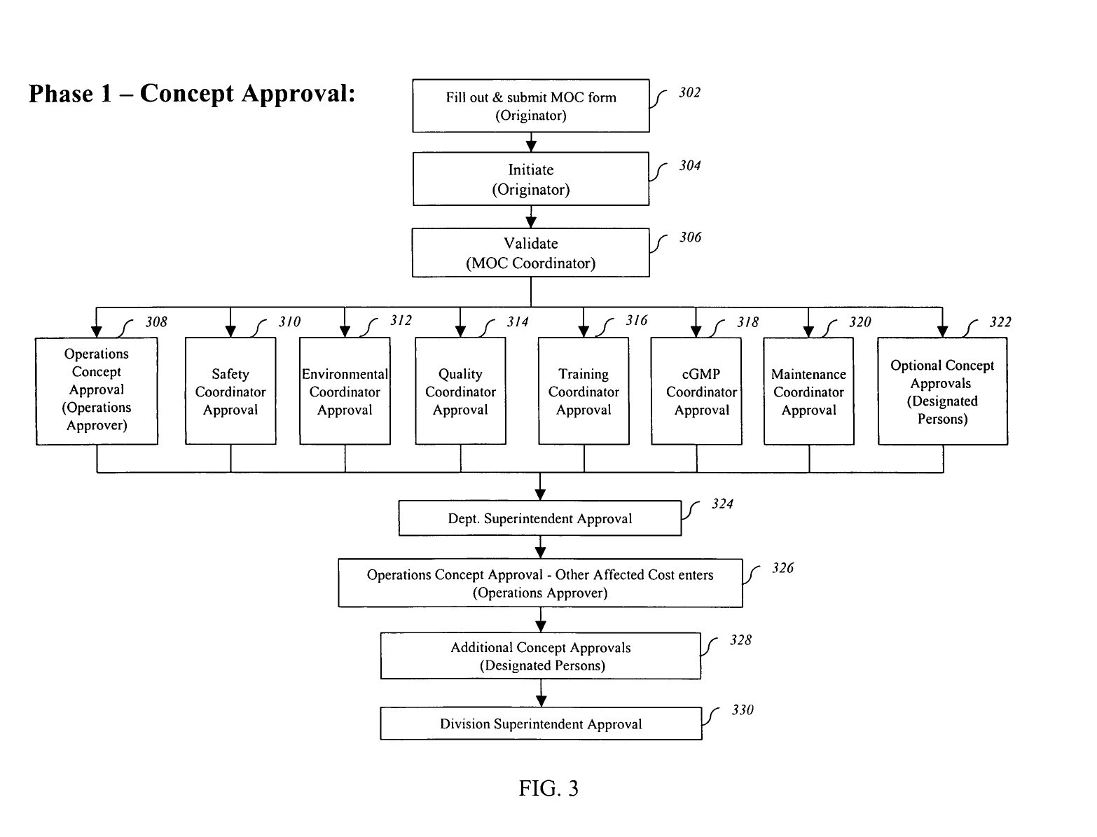

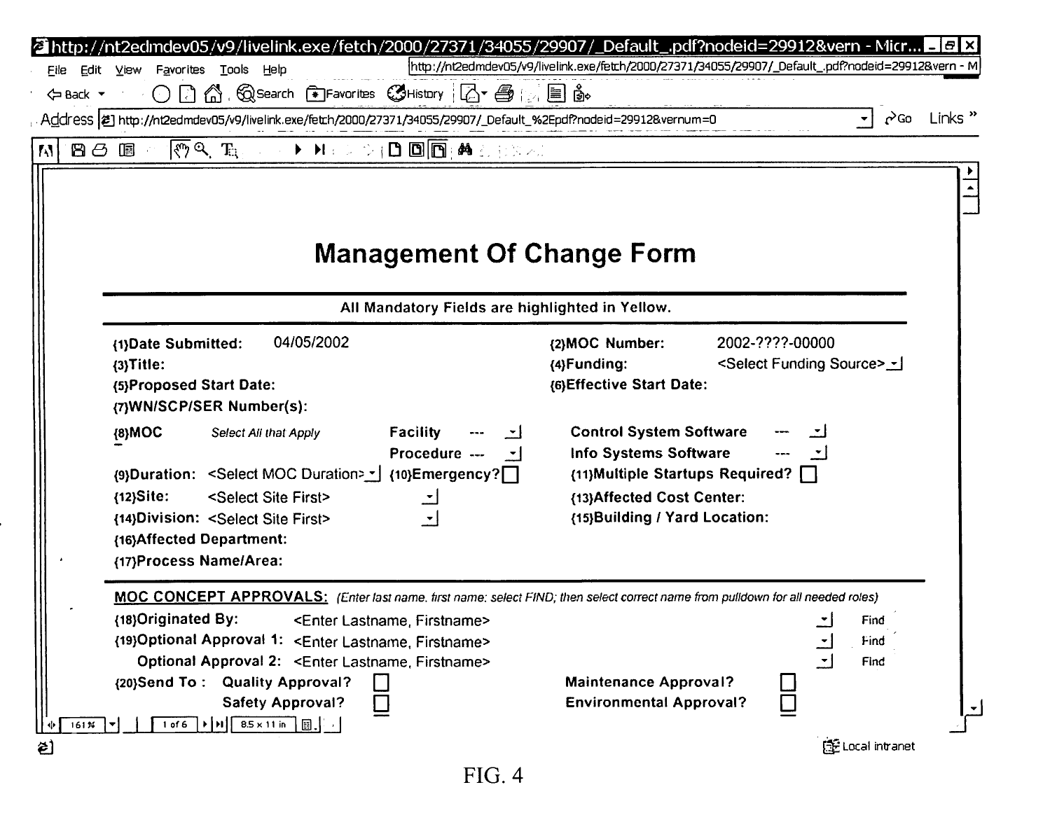

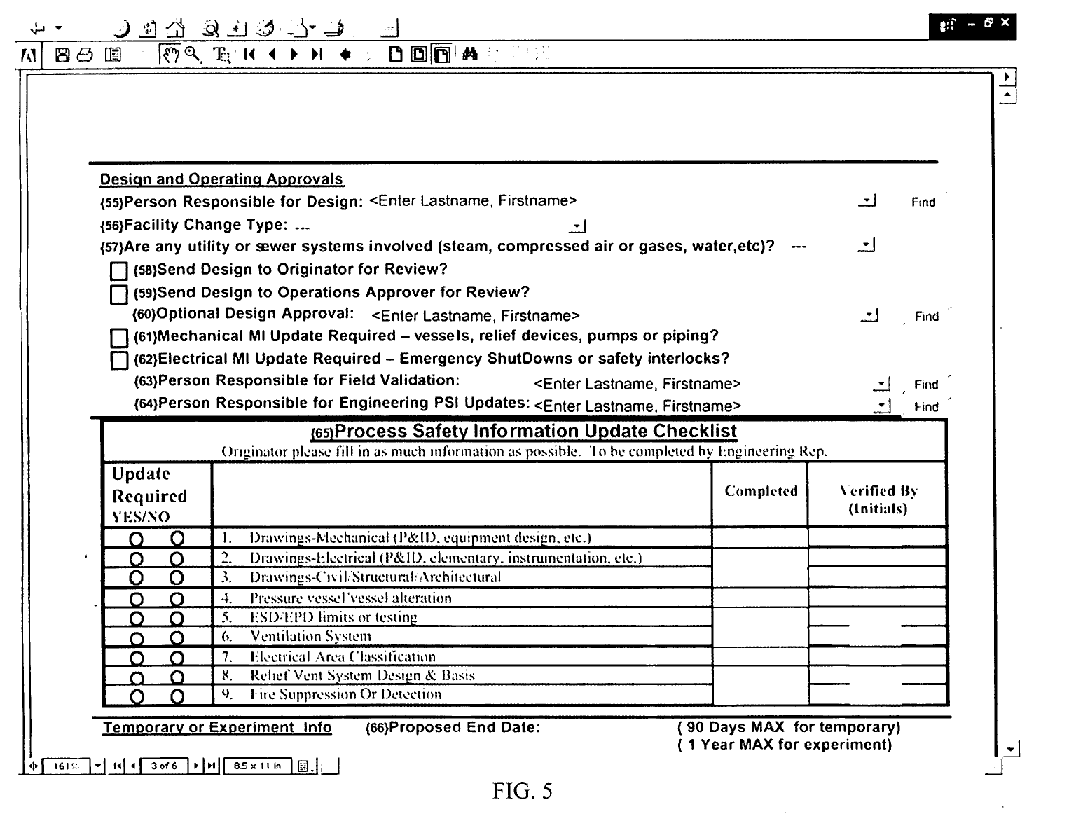

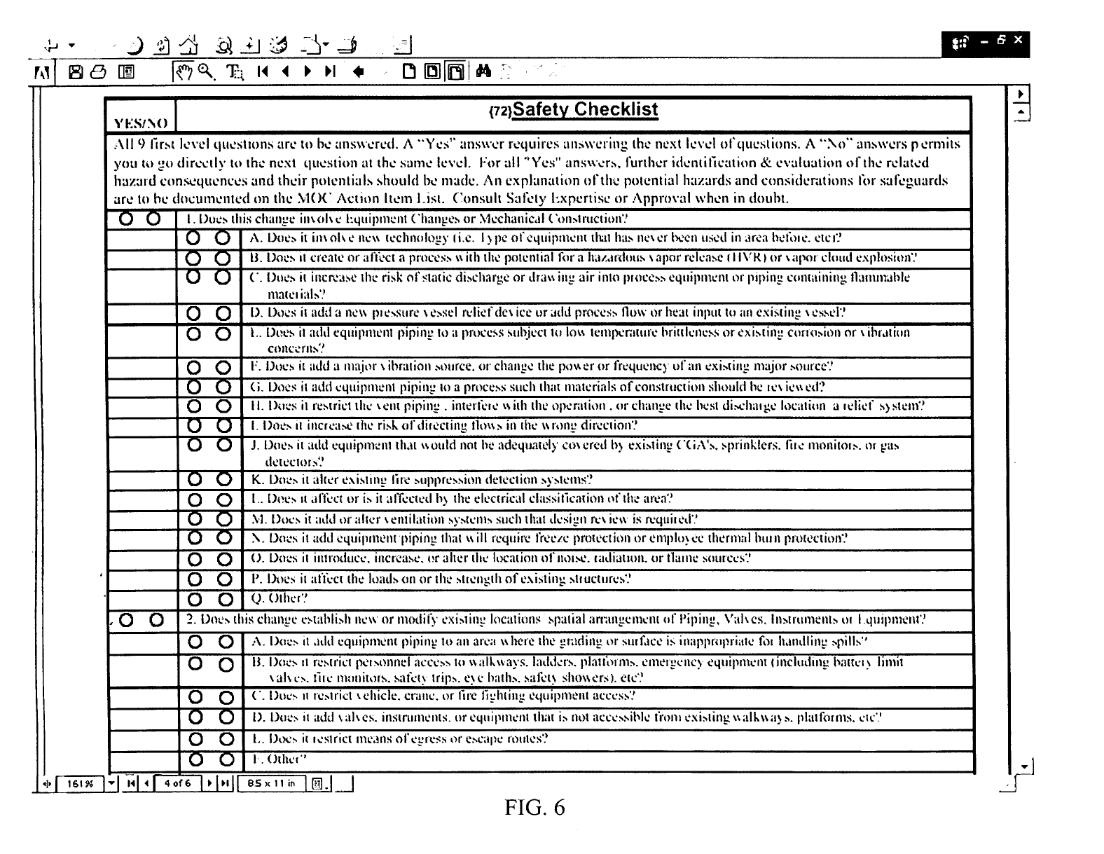

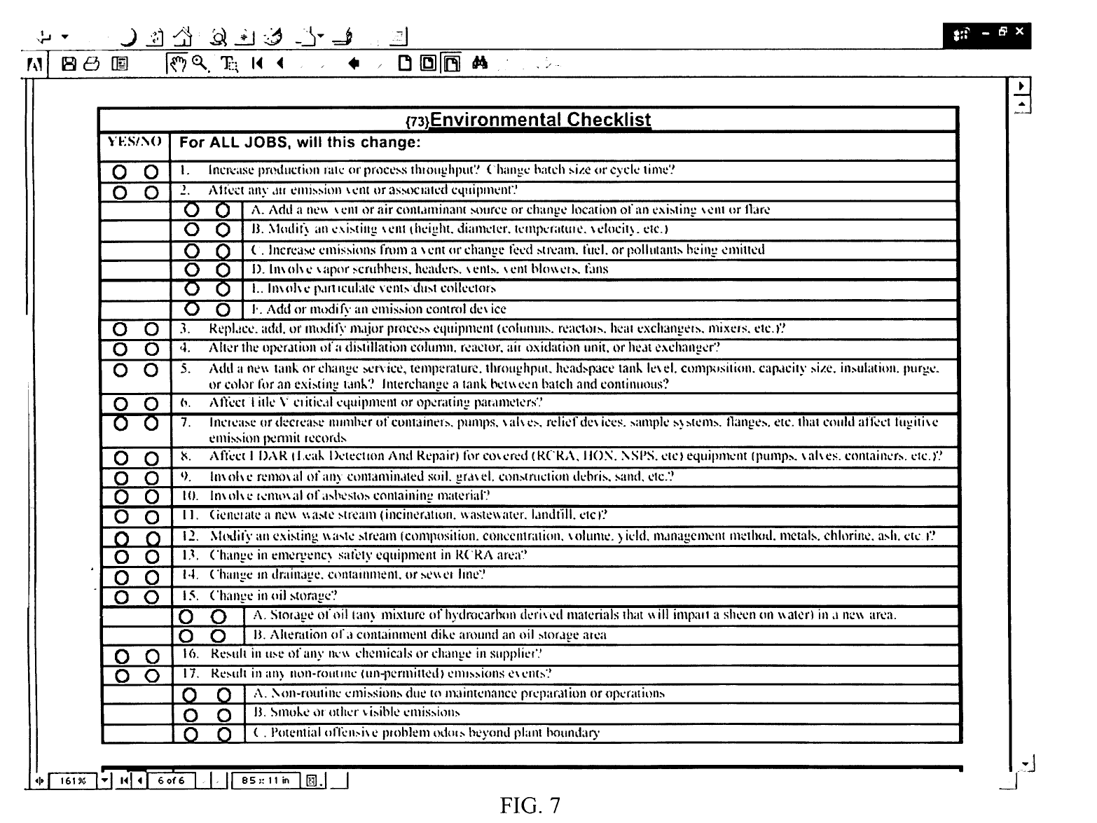

FIG. 3 is a flowchart illustrating the steps occurring during the Concept Approval phase 202 in an embodiment of this invention. In the embodiment shown, completion of a MOC form 302 is the first step. FIGS. 4-7 are screenshots, illustrating a MOC form in one embodiment of this invention. The MOC form shown in these figures provides fields for an originator to enter details about the change and to specify the types of approval that are relevant to the change. As noted above, the information contained in the MOC form may also be provided by an automated system.

Once the MOC form is complete, the MOC process is initiated 304. In the embodiment shown, the originator is responsible for initiation and initiation occurs as soon as the originator submits the MOC form. The originator specifies the desired start date for the modified process, in other words the date that the change will be implemented in the production process. The desired start date is preferably chosen to allow sufficient time for all approvals, reviews, design, and other tasks to be completed.

Once a change has been initiated, it is subject to validation 306. In the embodiment shown, a MOC coordinator is responsible for the validation of a change. In another embodiment, an expert system is utilized to determine whether a change is valid.

Following validation, a change flows through the approval process. The approval steps shown 308-322 may or may not be relevant to a particular change as specified by the MOC form. If any of the relevant approvals are withheld, the MOC system routes the proposed change to the originator for action. Upon receiving notice of the withheld approval, the originator may choose to amend or take some other action to gain approval for the change or may cancel the change.

In the embodiment shown in FIG. 3, eight potentially relevant approval steps are shown. These eights steps are: Operations Concept Approval 308, Safety Coordinator Approval 310, Environmental Coordinator Approval 312, Quality Coordinator Approval 314, Training Coordinator Approval 316, Maintenances Coordinator Approval 318, cGMP Coordinator Approval 320, or potentially relevant Concept Approval 322.

In the embodiment shown in FIG. 2, Operations Concept Approval 208 is relevant to all changes. The remainder of the approval steps are deemed relevant by the MOC system based on input received in a MOC form. For example, if the originator checks the box marked Safety Coordinator Approval on the MOC form, then the MOC system executes the Safety Coordinator Approval step 310.

For some or all of the approval steps shown in FIG. 3, the originator may specify a responsible party for approval. The originator may also optionally specify specific individuals for approval of a change. In such a case, the MOC form is routed to that individual for approval.

If each of the workflow steps that the MOC system executes after validation results in an approval, then the Concept Approval phase 202 continues. The remaining process steps are all potentially relevant and occur in succession. Only those process steps that are identified as relevant based on the MOC form will be executed. If an approval step is relevant, the step must result in an approval before a subsequent step may occur.

For example, in the embodiment shown, a Department Superintendent Approval may be relevant to a particular change. If such an approval is deemed relevant by the MOC system based on entries in the MOC form, then the MOC system executes the Department Superintendent Approval step 324.

If the originator makes entries to the MOC form indicating that the Operations Concept Approval—Other Affected Cost Enters step 326 is relevant to a change, then the MOC system executes this step. The operations approver is responsible for this step.

If the originator designated specific persons for Additional Concept Approvals on the MOC form, then the MOC system executes the Additional Concept Approvals step 328. The persons designated in the MOC form fields that triggered this step are responsible for its completion. The MOC system forwards the change to the designated persons for their approval.

The originator may also specify that Division Superintendent Approval is relevant to a change. If so, the MOC system executes the Division Superintendent Approval step 330. Once all of the relevant approval steps have executed, the Execution phase of the MOC process 204 begins.

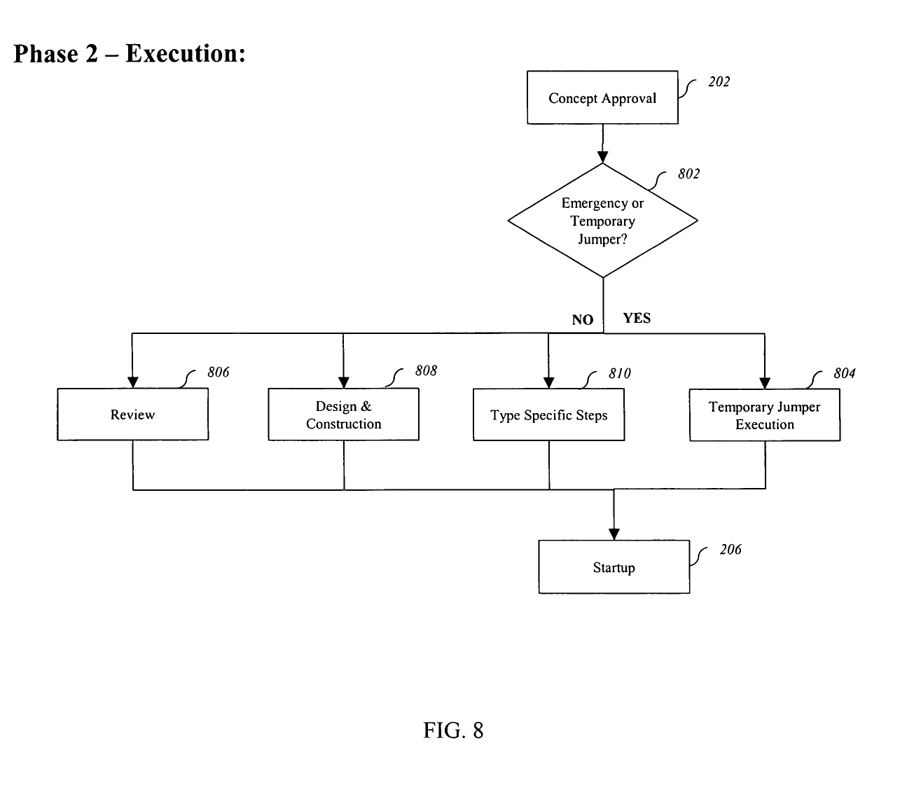

FIG. 8 is a flowchart illustrating the steps that occur during the execution phase 204 of the embodiment shown in FIG. 1. Once the Concept Approval phase 202 is complete, execution begins. The change is evaluated to determine whether the change is an emergency or temporary jumper based on the MOC form 802. If so, temporary jumper execution occurs 804. A temporary jumper comprises a short term bypass of a shutdown, interlock or control to do maintenance work due, for example, to an instrument or mechanical failure. If the change is not a temporary jumper, the change is reviewed 806 (e.g. for any needed safety, environmental and/or quality reviews), facilities, hardware, or software required by the change are designed and constructed 808, and steps specific to the type of change are performed 810. Steps specific to the type of change include procedure updates, control system updates (computers, programmable logic controllers, distributed control systems, etc. which control the production process) and information system updates (computer systems which provide information and do not control the production process). When these steps are complete, the MOC process proceeds to phase 3, Startup 206.

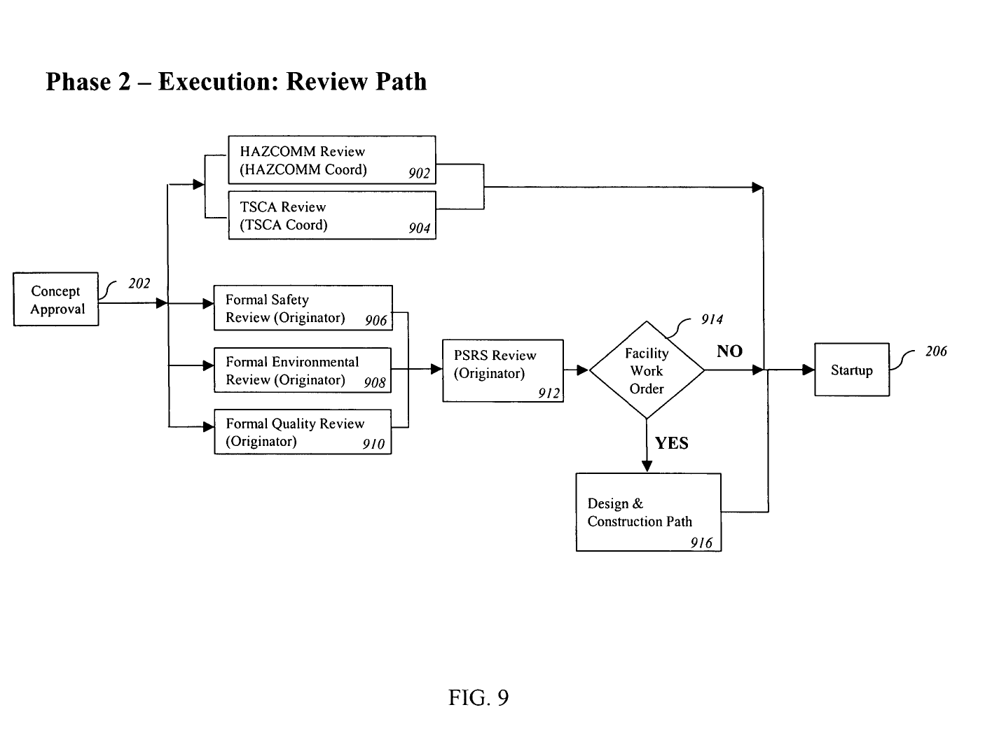

FIG. 9 is a flowchart illustrating the review process 806 of the embodiment shown in FIG. 8. All of the workflow steps in the Review path are potentially relevant to any type of change. In the embodiment shown, an originator may specify in the MOC form that HAZCOMM (OSHA's Hazard Communication Standard) review 902 and/or TSCA (Toxic Substances Control Act) review 904 are relevant to the change. The HAZCOMM Coordinator is responsible for the HAZCOMM review 902, while the TSCA Coordinator is responsible for the TSCA review 904. These steps may be relevant, for example, to changes related to certain government regulations.

Additional review may be relevant to a change. For example, in the embodiment shown, the originator may specify that Formal Safety review 906, formal environmental review 908, and formal quality review 910 are to be performed for a change. Once these reviews are performed, PSRS review may be performed 912. The MOC system then determines if a facility work order is to be or has been generated. If so, design and construction 914 occur. If not, the execution phase 204 ends, and the startup phase 206 begins.

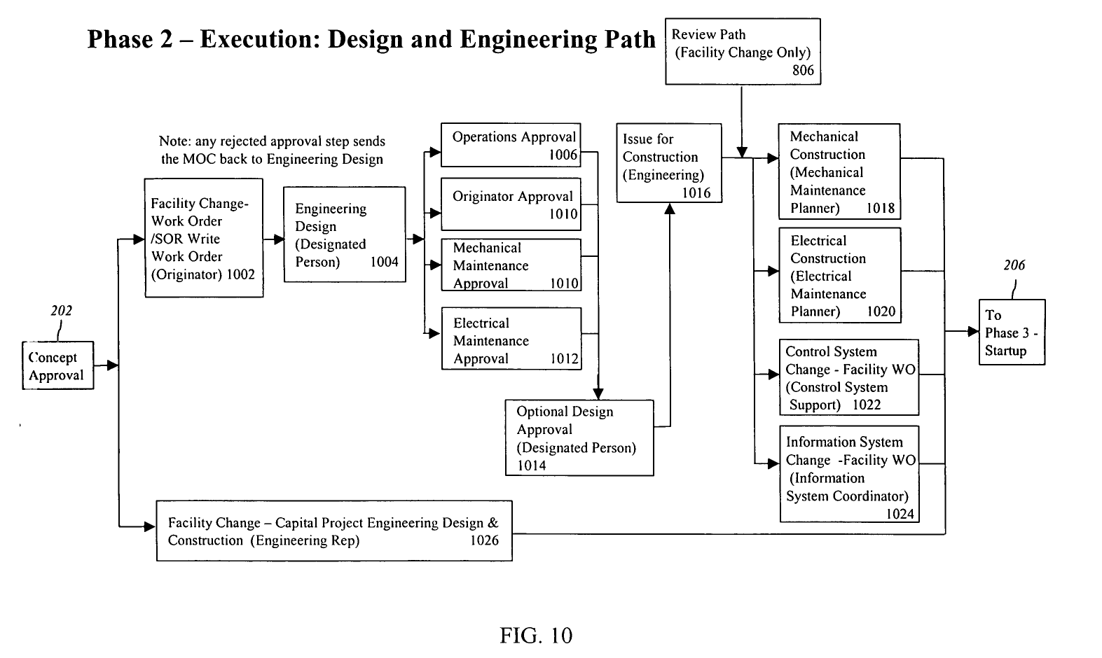

FIG. 10 is a flow chart illustrating the design and construction process 808 shown in FIG. 8. The process shown begins once a concept has been approved 202. The work order is created 1002. An engineering design is created based on the work order 1004. In the embodiment shown, the engineering design is subject to operations approval 1006, originator approval 1008, mechanical maintenance approval 1010, and/or electrical maintenance approval 1010. As discussed herein, various of these approval steps may not be relevant to a particular change. The originator may also specify designated persons to approve the design 1014.

Once the approval process is complete, the change is issued for construction (engineering) 1016. Mechanical 1018 and electrical 1020 construction can begin. And changes to control systems 1022 and information systems 1024 needed to support the change can be designed. Once the construction and engineering is complete, the MOC process proceeds to startup 206.

Alternatively, for a facility Change—Capital Project, one process occurs 1026. A Capital Project provides the opportunity to bypass the execution phase if the change is a capital project and has its own special execution process. Once this process is complete, the MOC process proceeds to startup 206.

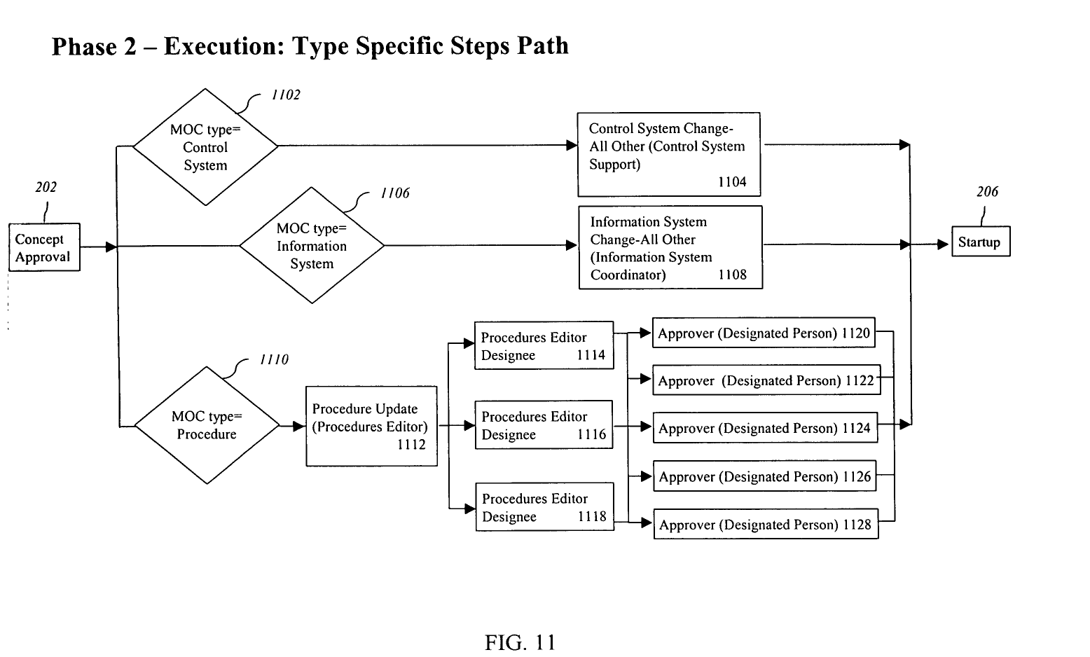

FIG. 11 is a flow chart illustrating the type-specific process 801 shown in FIG. 8. The type-specific process shown begins after concept approval 202. The MOC process of the embodiment shown in FIG. 11 includes three distinct sub-paths that each correspond to a specific MOC type: control system changes, information system changes, and procedural changes. The originator may select more than one MOC type on the MOC form. The MOC system may therefore execute more than one sub-path. The sub-paths may be executed sequentially or in parallel.

If the originator selects Control System as a MOC type on the MOC form 1102, the MOC system executes the Control System Change sub-path, which consists of one workflow step, Control System Change—All Other 1104. In the embodiment shown, Control System Support is responsible for this workflow step.

If the originator selects Information Systems as a MOC type on the MOC form 1106, then the MOC system executes the Information Systems Change sub-path, which also consists of one workflow step, Information System Change—All Other 1108. The Information System Coordinator is responsible for this step.

If the originator selects Procedure as a MOC type on the MOC form 1110, then the MOC system executes the procedural change sub-path, which consists of several workflow steps for updating and approving procedures. First, the MOC system executes a procedure update 1012. During this process the procedures editor is responsible for updating procedures related to the change. The procedures editor also designates several people (Procedure Editor Designees) to review the proposed procedure updates 1014, 116, and 1018. When the procedures editor designees have completed their respective reviews, the MOC system routes the change to several designated approvers 1022-1028. Each approver independently reviews and approves the change and the procedure editor's updates to the change. Once the approvals are complete, the Startup phase 206 begins.

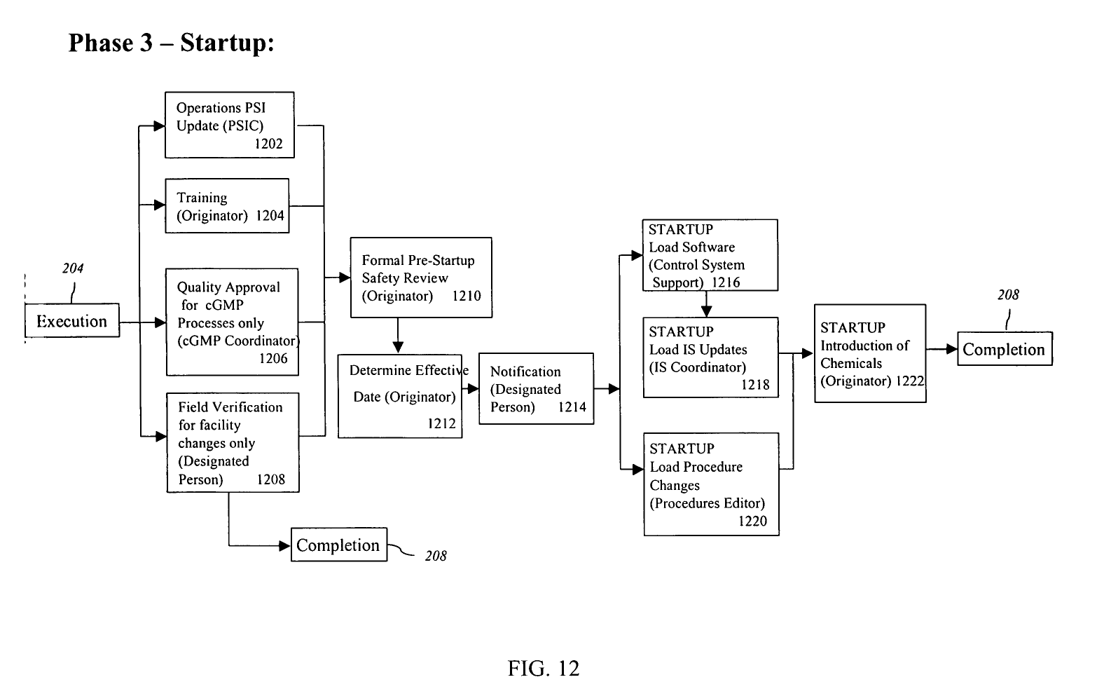

The Startup phase 202 includes change training, safety validation, and change implementation. FIG. 12 is a flowchart illustrating the Startup phase 202 in one embodiment of this invention. The startup phase begins with any number of four potentially relevant workflow steps. The MOC system determines which of these workflow steps to execute based on the originator's entries in the MOC form. These steps include operations PSI (Process Safety Information, a list of over twenty documents including engineering drawings and specifications, operating procedures etc.) update 1202, training 1204, quality approval 1206, and field verification 1208. The training step may be relevant due to company policy or regulatory concerns. In the embodiment shown, the quality approval process 1206 is relevant only for processes covered by pharmaceutical regulations (i.e. cGMP). Similarly, the field verification process 1208 is relevant only for facility changes.

The MOC system next executes the formal pre-startup safety review 1210. Whether or not this step is relevant is dependent on entries in the MOC form. The originator is responsible for this step's completion.

The MOC system next determines the effective date of the change 1212. Once the effective date has been determined, notification is performed 1214. All affected persons may be notified including operators, supervisors and staff in the area. The originator uses the MOC form to designate a person to be responsible for notification. Notification may be mandated at least partially to satisfy regulatory requirements.

Implementation of the change occurs on the effective date. The process steps executed by the MOC system are determined based on the type of change. If the change relates to software, at startup, the software is loaded 1216 and the IS updates are loaded 1218. If the change relates to a procedure, the procedure changes are loaded 1220. Once the software and/or procedures are loaded, the introduction of chemicals may begin 1222. This step is generally a key milestone in the regulatory process. After chemicals are introduced, the Startup phase 206 is complete and the Completion phase 208 begins. If the MOC form lists the MOC type as Procedure, Control System Software, or Information Systems Software, then the MOC system may execute additional steps before chemicals can be introduced.

In one embodiment, if the originator selects Control System Software as one of the MOC types on the MOC form, then the Load Software step occurs 1216. Control System Support is responsible for this step. If the originator selects both Control System Software and Information Systems Software as MOC types on the MOC form, then the MOC system executes the Load Software step 1216 before executing the Load IS Updates step 1218. In such an embodiment, the Load IS Updates step 1218 also executes if the originator selects Information Systems Software, but does not select Control System Software as one of the MOC types. In either case, the Information Systems Coordinator is responsible for this step's completion.

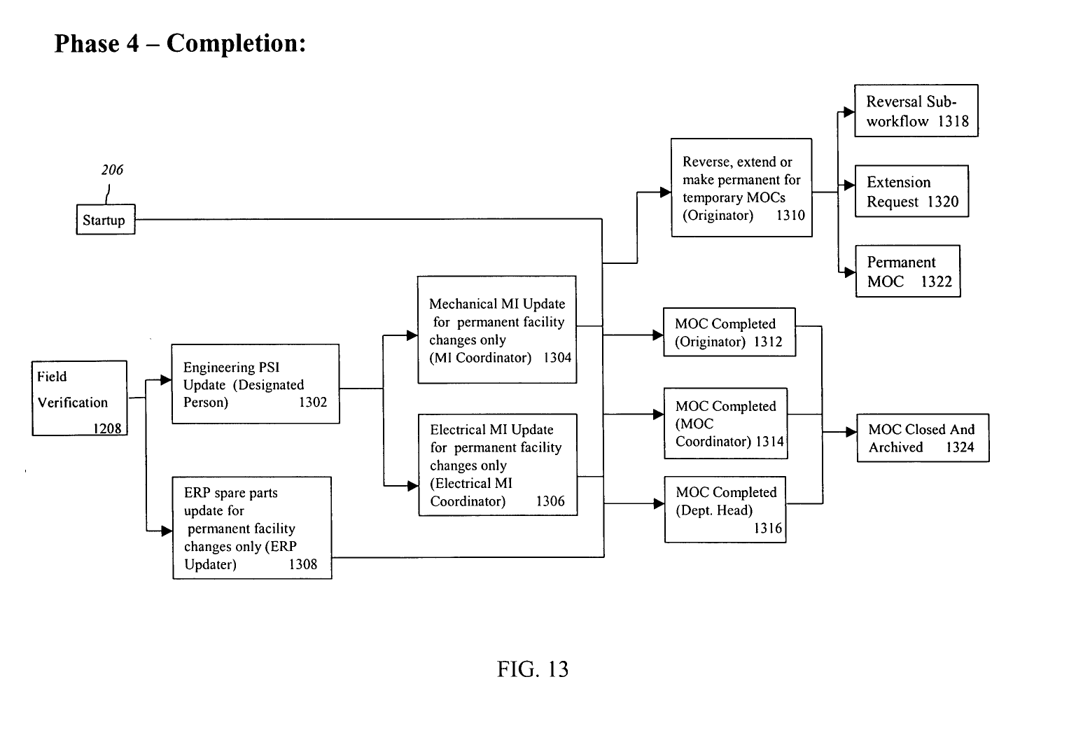

During the Completion phase 208 documents are updated, temporary and emergency changes are processed, and the MOC is closed and archived. FIG. 13 is a flowchart illustrating the Completion phase 208 in one embodiment of this invention.

The Completion phase 208 begins when the startup phase 206 is complete. The engineering PSI is updated 1302. In the embodiment shown, document updates 1304-1308 occur only for permanent facility changes. Documents updates include mechanical updates 1304, electrical updates 1306 and ERP spare part updates 1308. The Mechanical MI Update 1304 and Electrical MI Updates 1306 follow the completion of the Engineering PSI Update 1302 if the MOC form indicates that these steps are relevant. The MI coordinator is responsible for the Mechanical MI Update step, while the Electrical MI Coordinator is responsible for the Electrical MI Update step.

Following the completion of the Startup phase, or the document updates if relevant, if the MOC form indicates a temporary change, the MOC system executes the Reverse, Extend or Make Permanent step 1310. During this step the originator is responsible for determining whether the temporary or emergency change should be reversed 1318, extended 1320, or made permanent 1322. The time period for a temporary change is 90 days. A request for extension triggers an approval step which goes to the Department Superintendent. If approved, the temporary change is extended for another 90 days. A request to make permanent returns instructions to initiate a new MOC (since re-approval is required for a permanent change). A request to reverse the change triggers a reverse workflow which basically repeats the execution, start-up and completion phases (but does not require re-approval since the process is being returned to its original state).

Once the relevant startup phase steps are complete, the MOC system executes two or more completion steps 1312-1316. In the embodiment shown, the MOC Completed—Originator 1312 and the MOC Completed—MOC Coordinator 1314 steps are relevant to all changes. During the MOC Completed—Originator step 1312, the originator confirms that all previous workflow steps are complete. During the MOC Completed—MOC Coordinator step 1314, the MOC coordinator confirms that all previous workflow steps are complete and verifies that all proper documentation has been prepared. If the originator makes entries to the MOC form indicating that the MOC Completed—Department Head step 1316 is also relevant, then the MOC system executes this step as well, in which the Department Head verifies that all previous workflow steps are complete. After each of the MOC Completed steps are complete, documentation produced during the MOC process is closed and archived 1324.

Although a system of the present invention has been described in detail with respect to one possible embodiment relating to Management of Change in a chemical industry setting, it will be appreciated that the systems and methods of the present invention are capable of use in other areas. Accordingly, the present invention is not limited to the embodiment described in detail herein.

1. A method comprising:
receiving a change request comprising a plurality of tasks;
initiating the change request;
validating the change request; and
approving the change request.

2. The method of claim 1, further comprising executing the change request.

3. The method of claim 2, wherein executing the change request comprises:
designing a process corresponding to the change request;
constructing the process corresponding to the change request; and
implementing the process corresponding to the change request.

4. The method of claim 2, wherein executing the change request comprises generating an audit trail.

5. The method of claim 1, wherein validating the change request comprises performing a safety validation.

6. The method of claim 1, further comprising receiving at least one approval type prior to approving the change.

7. The method of claim 6, wherein the approval type comprises at least one of an operations concept approval, a safety coordinator approval, an environmental coordinator approval, a quality coordinator approval, a training coordinator approval, a maintenance coordinator approval, and a concept approval.

8. The method of claim 7, wherein the concept approval comprises at least one of a HAZCOMM (OSHA's Hazard Communication Standard) review, a TSCA (Toxic Substances Control Act) review, a formal safety review, a formal environmental review, and a formal quality review.

9. The method of claim 1, further comprising automatically routing the change request to a user responsible for completion of a task associated with the change request.

10. The method of claim 1, wherein the change request is associated with one of a facility change, a bill of materials change, an operations procedure change.

11. A computer-readable medium comprising computer-executable program code, the computer-readable medium comprising:
program code for receiving a change request comprising a plurality of tasks;
program code for initiating the change request;
program code for validating the change request; and
program code for approving the change request.

12. The computer-readable medium of claim 11, further comprising program code for executing the change request.

13. The computer-readable medium of claim 12, wherein program code for executing the change request comprises:
program code for designing a process corresponding to the change request;
program code for constructing the process corresponding to the change request; and
program code for implementing the process corresponding to the change request.

14. The computer-readable medium of claim 12, wherein program code for executing the change request comprises program code for generating an audit trail.

15. The computer-readable medium of claim 11, wherein program code for validating the change request comprises program code for performing a safety validation.

16. The computer-readable medium of claim 11, further comprising program code for receiving at least one approval type prior to program code for approving the change.

17. The computer-readable medium of claim 11, further comprising program code for automatically routing the change request to a user responsible for completion of one of the plurality of tasks.
